(19) United States
(12) Patent Application Publication
(10) Pub. No.: US 2025/0226504 A1
(43) Pub. Date: Jul. 10, 2025

(54) BATTERY MODULE AND METHOD FOR MANUFACTURING BATTERY MODULE

(71) Applicant: HONDA MOTOR CO., LTD., Tokyo (JP)

(72) Inventors: Hidemasa USUI, Saitama (JP); Hirokazu WATANABE, Saitama (JP)

(21) Appl. No.: 19/006,240

(22) Filed: Dec. 31, 2024

(30) Foreign Application Priority Data
Jan. 9, 2024 (JP) 2024-001346

(51) Int. Cl. H01M 50/242; H01M 50/204; H01M 50/249; H01M 50/289

(52) U.S. Cl. CPC H01M 50/242; H01M 50/204; H01M 50/249; H01M 50/289; H01M 2220/20

(57) ABSTRACT

Provided is a battery module including: a battery cell stack that has a plurality of battery cells stacked atop one another; a pair of plate-shaped members that are provided on the two ends of the battery cell stack in the stacking direction; fluid cushions that are disposed between the plurality of battery cells; and holders that support regions of the fluid cushions, the regions not facing the battery cells.

This application is based on and claims the benefit of priority from Japanese Patent Application No. 2024-001346, filed on 9 Jan. 2024, the content of which is incorporated herein by reference.

### BACKGROUND OF THE INVENTION

### Field of the Invention

The present invention relates to a battery module and a method for manufacturing the battery module.

### Related Art

In recent years, research and development that pertain to battery modules contributing to the enhancement of energy efficiency have been carried out in order to ensure that more people have access to reliable, sustainable, and advanced energy at reasonable cost.

European Patent Application, Publication No. 3886202 describes a battery system provided with a multilayer body including a plurality of battery cells stacked along an imaginary reference axis. In this configuration, a pack frame includes: a first endplate and a second endplate; one or more fluid springs configured to hold a fluid; one or more fluid pressure adjusting means configured to adjust a fluid pressure within the at least one fluid spring; and a control unit configured to control the one or more fluid pressure adjusting means. The stack is placed between the first and second endplates. Each of the one or more fluid springs is positioned between the first and second endplates, and is configured to exert pressure on at least one battery cell in a direction along the reference axis. Each of the fluid pressure adjusting means is connected to one or more fluid springs. A) at least one of the fluid springs comprises an elastic device, and each of the fluid pressure adjusting means is configured to generate or to adjust, when the one or more connected fluid springs each hold a fluid, a negative pressure in the fluid within the connected fluid springs; and/or B) the control unit is configured to receive a safety check signal from at least one safety check sensor, the control unit is further configured to evaluate whether the received safety check signals may indicate a safety critical situation, and to operate the fluid on the basis of the evaluation that the safety check signal(s) may indicate a safety critical situation, and the fluid pressure adjusting means reduces the fluid pressure in the fluid springs.

Patent Document 1: European Patent Application, Publication No. 3886202

### SUMMARY OF THE INVENTION

However, the battery system in European Patent Application, Publication No. 3886202 is provided with the fluid pressure adjusting means and thus has a reduced energy density. As such, avoiding the use of the fluid pressure adjusting means may be considered in order to suppress the reduction in the energy density of the battery system.

However, the fluid pressure in the fluid springs increases when the fluid springs contract in the stacking direction of the battery cells and expand in a direction perpendicular to the stacking direction of the battery cells in response to the expansion of the battery cells that is associated with the charging. Thus, repeatedly charging/discharging the battery cells will cause the fluid springs to be more susceptible to damage and also cause the endplates to be more susceptible to damage, thereby reducing the durability of the battery module.

An object of the present invention is to provide a battery module that can suppress a reduction in energy density and improve durability.
(1) A battery module including: a battery cell stack that has a plurality of battery cells stacked atop one another; a pair of plate-shaped members that are provided on the two ends of the battery cell stack in the stacking direction; fluid cushions that are disposed between the plurality of battery cells; and holders that support regions of the fluid cushions, the regions not facing the battery cells.
(2) The battery module according to aspect (1), further including positioners that position the holders, wherein the holders are integrated with the positioners.
(3) In the battery module according to aspect (1) or (2), spaces are present between side surfaces of the holders and side surfaces of the battery cells.
(4) In the battery module according to any one of aspects (1) to (3), the holders have side surfaces that face the battery cells, and the side surfaces that face the battery cells have a concave surface shape.
(5) In the battery module according to any one of aspects (1) to (4), the battery cells are provided with tab leads, and the tab leads are each disposed between adjacent ones of the holders.
(6) A method for manufacturing the battery module according to any one of aspects (1) to (5), the method including: providing battery module precursors by integrating first members corresponding to upper halves of the holders and second members corresponding to lower halves of the holders with the battery cells with respect to the stacking direction of the battery cell stack; and stacking the battery module precursors with the fluid cushions therebetween.

The present invention provides a battery module that can suppress a reduction in energy density and improve durability.

### BRIEF DESCRIPTION OF THE DRAWINGS

FIG. 1 is a cross-sectional view illustrating a battery module according to one embodiment of the present invention;

FIG. 2 is an enlarged partial cross-sectional view illustrating the state of the battery module in FIG. 1 as fully charged;

FIG. 3 is an enlarged partial cross-sectional view illustrating the state of the battery module in FIG. 1 as fully charged; and

FIG. 4 is a cross-sectional view illustrating a method for manufacturing the battery module in FIG. 1.

### DETAILED DESCRIPTION OF THE INVENTION

The following describes embodiments of the present invention by referring to the drawings.

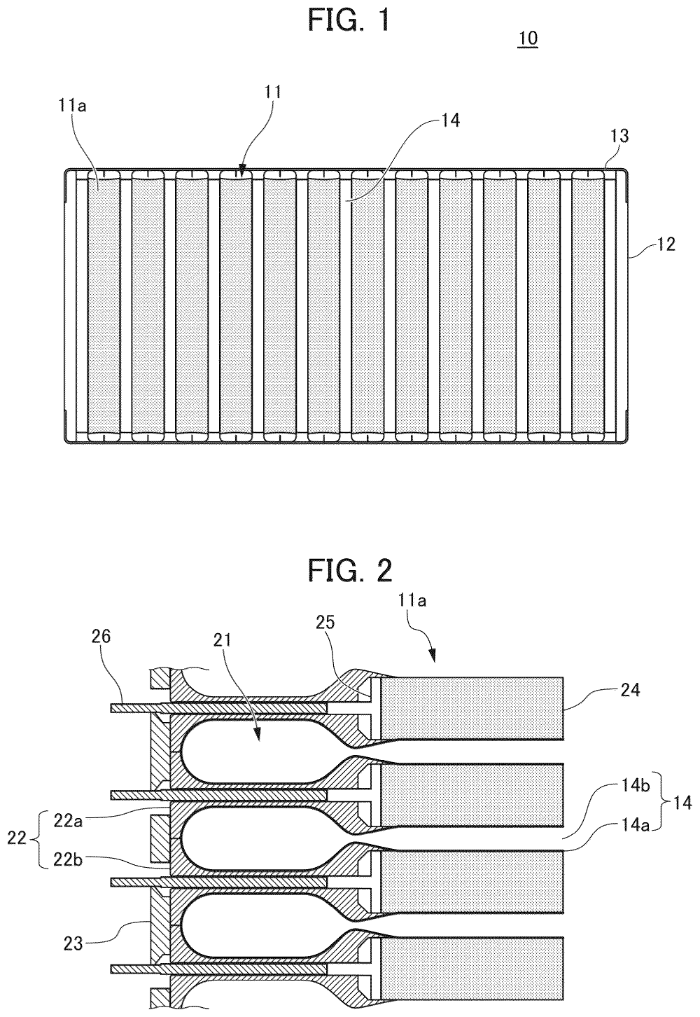

FIG. 1 illustrates a battery module according to one embodiment of the present invention.

A battery module 10 includes: a battery cell stack 11 that has a plurality of battery cells 11a stacked atop one another; endplates 12, which are a pair of plate-shaped members provided on the two ends of the battery cell stack 11 in the stacking direction; and binding bars 13, which are confinement members that confine the battery cell stack 11 between the pair of endplates 12. The binding bars 13 are installed on an upper portion and a lower portion, i.e., two sites, in the drawing. The confining pressure of the binding bars 13 is not particularly limited, but may be, for example, 1.0 MPa to 2.5 MPa. The battery module 10 has fluid cushions 14 disposed between the plurality of battery cells 11a and between battery cells 11a and the endplates 12.

Note that fluid cushions 14 do not necessarily need to be disposed between battery cells 11a and the endplates 12.

As depicted in FIG. 2, the battery module 10 further includes holders 22 that support regions 21 of the fluid cushions 14 that do not face the battery cells 11a. Thus, the durability of the battery module 10 is improved. Specifically, although the fluid cushions 14, in response to the expansion of the battery cells 11a that is associated with the charging, contract in the stacking direction of the battery cell stack 11 and expand in a direction perpendicular to the stacking direction of the battery cell stack 11, the fluid cushions 14 are unlikely to become damaged owing to the rigidity of the holders 22. Meanwhile, the expansion of the fluid cushions 14 is controlled, and the expansion pressures of the battery cell stack 11 in the stacking direction are canceled out between adjacent fluid cushions 14, so that the holders 22 can be made thin and lightweight. In this regard, the holders 22 are each formed from a first member 22a corresponding to the upper half and a second member 22b corresponding to the lower half with respect to the stacking direction of the battery cell stack 11.

The fluid cushions 14 are each formed by filling an outer packaging member 14a with a fluid 14b. A material for forming the outer packaging member 14a is not particularly limited as long as the same has such stretchability as to respond to the expansion/contraction of the battery cells 11a that is associated with the charging/discharging, and, for example, rubber, an elastomer, or a stretchable resin can be the material. For example, the rubber can be ethylene-propylene rubber, nitrile rubber, fluororubber, chloroprene rubber, or urethane rubber. For example, the elastomer can be a styrenic elastomer or an olefinic elastomer. For example, the stretchable resin can be polypropylene or a polyamide. The outer packaging member 14a may be formed by a stretchable resin film clamping an aluminum film. As a result, gas permeation is suppressed. The fluid 14b may be a liquid or a gas, but is preferably a gas in view of the smoothness in responding to expansion/contraction of the battery cell 11a that is associated with the charging/discharging.

A material for forming the holders 22 is not particularly limited as long as the same has high rigidity, and may be, for example, a resin.

When the plurality of battery cells 11a have been fully charged, the regions 21 of the fluid cushions 14 that do not face the battery cells 11a are in contact with substantially the entirety of the holders 22; and when the plurality of battery cells 11a have not been fully charged, the regions 21 are in contact with the regions of portions of the holders 22.

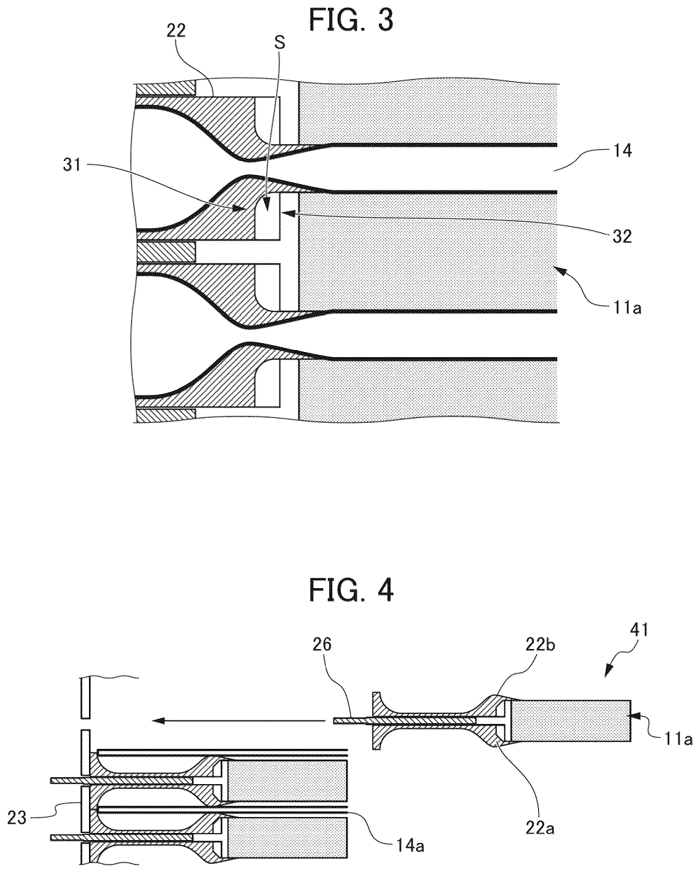

As depicted in FIG. 3, the battery module 10 has a space S between a side surface 31 of the holder and a side surface 32 of the battery cell. Thus, even when the expansion pressure of the region 21 of the fluid cushion 14 that does not face the battery cell 11a is applied to the holder 22 when the plurality of battery cells 11a have been fully charged, an external force is unlikely to be applied to the side surface 32 of the battery cell, and the side surface 32 of the battery cell 11a is unlikely to be damaged.

In the specification and the claims, upper surfaces and lower surfaces mean surfaces substantially perpendicular to the stacking direction of the battery cell stack, and side surfaces mean surfaces substantially perpendicular to an upper surface or a lower surface.

The side surface 31 of the holder has a concave surface shape. Thus, if the battery cell 11a contains a sulfide-based electrolyte, a space in which the battery cell 11a expands is ensured even if a hydrogen sulfide gas is generated.

As depicted in FIG. 2, the battery module 10 further includes positioners 23 that position the holders 22. The holders 22 are integrated with the positioners 23. Thus, the ease of manufacture of the battery module 10 is enhanced.

As depicted in FIG. 2, the battery cells 11a each have an electrode multilayer body 24 packaged by a laminate film 25 and is provided with a tab lead 26 projecting from the laminate film 25. The tab leads 26 are disposed between adjacent holders 22. Thus, even if stress is applied to the tab leads 26 when the battery cells 11a, while in a fully charged state, vibrate due to, for example, vibrations of a vehicle body, damage to the tab leads 26 is suppressed because the tab leads 26 are supported by the holders 22 and the regions 21 of the fluid cushions 14 that do not face the battery cells 11a. In this regard, even when the battery cells 11a are not fully charged, damage to the tab leads 26 is suppressed because the tab leads 26 are supported by the holders 22. Furthermore, since the holders 22 are disposed in the dead spaces between tab leads 26, a reduction in the energy density of the battery module 10 is suppressed.

The electrode multilayer body 24 has a plurality of positive electrodes and a plurality of negative electrodes that are stacked with an electrolyte therebetween. The electrolyte can be, for example, an electrolytic solution or a solid electrolyte. The electrolytic solution is retained by a separator.

The tab lead 26 may be a positive electrode tab lead or a negative electrode tab lead. The positive electrode tab lead is connected to the plurality of positive electrodes via a positive electrode tab. The negative electrode tab lead is connected to the plurality of negative electrodes via a negative electrode tab.

FIG. 4 illustrates a method for manufacturing the battery module 10.

First, first members 22a and second members 22b disposed with a prescribed spacing therebetween are integrated with fully charged battery cells 11a connected to tab leads 26, thereby providing battery module precursors 41. Then, the battery module precursors 41 are stacked with outer packaging members 14a therebetween, while positioning the holders 22 and the tab leads 26 by using positioners 23. In this situation, by gripping the first members 22a and the second members 22b of the battery module precursors 41, damage to the battery cells 11a can be suppressed. Furthermore, holders 22 are each formed from a first member 22a and a second member 22b that form adjacent battery module precursors 41. Subsequently, fluid cushions 14 are provided by filling the outer packaging members 14a with a fluid 14b.

For example, the first members 22a and the second members 22b are integrated with the battery cells 11a connected to the tab leads 26 by being bonded by an adhesive.

Note that the outer packaging members 14a may also be filled with the fluid 14b before the battery module precursors 41 are stacked.

Cells for forming the battery cells 11a are not particularly limited, but may be, for example, solid-state battery cells such as all-solid-state lithium-ion battery cells and all-solid-state lithium-metal battery cells, or nonaqueous electrolytic solution battery cells such as lithium-metal battery cells. Among these cells, all-solid-state lithium-metal battery cells are preferable.

In the following, descriptions are given of a situation in which all-solid-state lithium-metal battery cells form the battery cells 11a.

For example, the all-solid-state lithium-metal battery cell has a positive-electrode current collector, a positive-electrode composite layer, a solid electrolyte layer, a lithium metal layer, a negative-electrode current collector, which are successively stacked.

The positive-electrode current collector is not particularly limited, but may be, for example, aluminum foil. The positive-electrode composite layer contains a positive-electrode active material and may further contain, for example, a solid electrolyte, an electric conduction aid, and/or a binder.

The positive-electrode active material is not particularly limited as long as the same can occlude and release lithium ions, but may be, for example, LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiNn₂O₄, LiNiO₂, LiFePO₄, lithium sulfide, or sulfur.

A solid electrolyte for forming the solid electrolyte layer is not particularly limited as long as the same is a material that can conduct lithium ions, but may be, for example, an oxide-based electrolyte or a sulfide-based electrolyte.

The negative-electrode current collector is not particularly limited, but may be, for example, copper foil.

Although embodiments of the present invention have been described, the present invention is not limited to the embodiments described above, and the embodiments described above may be changed, as appropriate, within the scope of the spirit of the present invention.

### EXPLANATION OF REFERENCE NUMERALS

10: Battery module
11: Battery cell stack
11a: Battery cell
12: Endplate
13: Binding bar
14: Fluid cushion
14a: Outer packaging member
14b: Fluid
21: Region
22: Holder
22a: First member
22b: Second member
23: Positioner
24: Electrode multilayer body
25: Laminate film
26: Tab lead
31: Side surface of holder
32: Side surface of battery cell
41: Battery module precursor
S: Space

What is claimed is:

1. A battery module comprising:
a battery cell stack that has a plurality of battery cells stacked atop one another;
a pair of plate-shaped members that are provided on two ends of the battery cell stack in a stacking direction;
fluid cushions that are disposed between the plurality of battery cells; and
holders that support regions of the fluid cushions, the
regions not facing the battery cells.

2. The battery module according to claim 1, further comprising:
positioners that position the holders, wherein
the holders are integrated with the positioners.

3. The battery module according to claim 1, wherein spaces are present between side surfaces of the holders and side surfaces of the battery cells.

4. The battery module according to claim 1, wherein the holders have side surfaces that face the battery cells, and the side surfaces that face the battery cells have a concave surface shape.

5. The battery module according to claim 1, wherein
the battery cells are provided with tab leads, and
the tab leads are each disposed between adjacent ones of the holders.

6. A method for manufacturing the battery module according to claim 1, the method comprising:
providing battery module precursors by integrating first members corresponding to upper halves of the holders and second members corresponding to lower halves of the holders with the battery cells with respect to the stacking direction of the battery cell stack; and
stacking the battery module precursors with the fluid cushions therebetween.
